(19) United States
(12) Patent Application Publication
(10) Pub. No.: US 2021/0045371 A1
(43) Pub. Date: Feb. 18, 2021

(54) Mechanical Lure

(71) Applicant: Frank Gerald Pearce, Dallas, TX (US)

(72) Inventor: Frank Gerald Pearce, Dallas, TX (US)

(21) Appl. No.: 16/992,012

(22) Filed: Aug. 12, 2020

Related U.S. Application Data
(60) Provisional application No. 62/885,442, filed on Aug. 12, 2019.

(51) Int. Cl. A01K 85/18; F16H 57/04; F16H 57/029; F16H 21/44

(52) U.S. Cl. CPC A01K 85/18; F16H 57/0408; F16H 2057/02039; F16H 21/44; F16H 57/0464; F16H 57/029

(57) ABSTRACT

An improved mechanical lure with articulated legs preferably includes a housing, a gearbox, a pair of legs, a plastic sealing film, a gearbox case and at least one hook. The housing preferably includes an upper housing member and a lower housing member. The gearbox includes a gearbox unit, a winding reel and a pulling line. The winding reel with the pulling line and an offset drive shaft extend from the gearbox unit. The gearbox unit is filled with a lubricant. The plastic sealing film is applied to the gearbox unit to cover a plurality of holes including a lubricant injection opening. The gearbox case includes an upper case member and a lower case member. The gearbox case is sized to receive the plastic film wrapped gearbox unit. The pair of legs include first and second leg drive members. The first and second leg drive members are driven by the offset drive shaft. The appendage(s) of the mechanical lure is comprised of thermoplastic for increased buoyancy.

### CROSS-REFERENCE TO RELATED APPLICATIONS

This a nonprovisional patent application, which claims the benefit of provisional patent application No. 62/885,442 filed on Aug. 12, 2019.

### BACKGROUND OF THE INVENTION

### Field of the Invention

The present invention relates generally to lures for fishing and more specifically to an improved mechanical lure that contains a spring gearbox mechanism mounted inside the lure body which can be selectively activated through a sharp motion of a fishing rod which supplies a force that is transmitted to the fishing line and subsequently to the spring gearbox mechanism which winds the gearbox spring to store energy that can then be transmitted to a gear train that, in turn, drive the lure's external appendage(s). This winding and unwinding of the internal gearbox can be selectively repeated throughout the retrieval of the fishing lure for sustained appendage and lure motion.

### Discussion of the Prior Art

This invention is an improvement upon this inventor's prior mechanical lure embodiments which are described in U.S. Pat. Nos. 4,674,233, 4,831,767, 5,035,075 and 6,622,419 which are hereby incorporated by reference in their entirety. However, U.S. Pat. Nos. 4,674,233, 4,831,767, 5,035,075 and 6,622,419 do not teach or suggest an internal spring gearbox that is injected with an appropriate gearbox lubricant which gearbox is then firstly sealed with a plastic seal film and then secondly sealed with a plastic or rubber casing that forms an improved sealing method of the internal spring gearbox from water contaminants found in outdoor bodies of water suitable for fishing and from the leaching of the lubricant from the gearbox during lure use.

Accordingly, there is a recognized a need in the art for an improved mechanical fishing lure, which includes an internal spring gearbox injected with an appropriate lubricant; a plastic sealing film to act as a first seal of the gearbox; and a second plastic or rubber casing that further encloses and protects the internal spring gearbox from water particles and debris and from the leaching of the lubricant from the gearbox during lure use.

### SUMMARY OF THE INVENTION

The present invention discloses a substantial improvement over this inventor's previous mechanical lure embodiments and provides a marked improvement in the performance and service life of the mechanical lure. During this inventor's early development of a novel mechanical lure, it was discovered that a commercially available spring gearbox was best suited for this application. However, such commercially available gearboxes were fitted with a plurality of openings to facilitate gearbox assembly which, when incorporated into a mechanical fishing lure, allowed water to freely circulate within the gearbox. During this inventor's initial testing of this spring gearbox lure embodiment, it was further discovered that small particles and debris suspended in outdoor bodies of water, including salt residues in sea water, contaminated and fouled the internal plastic gears of the spring gearbox. Although a number of methods were used by this inventor over the years to try and improve water resistance within the spring gearbox, each did not deliver the desired gearbox protection. Furthermore, it was determined by this inventor that the injection of a suitable lubricant, and preferably a grease, into the spring gearbox provided improved spring gearbox gear function and improved the repulsion of water and debris from the gears and the gearbox. However, the previous lure embodiments failed to provide the necessary barrier to resist water from entering and circulating within the gearbox, thus allowing contaminants in and further preventing the introduction of a suitable lubricant into the gearbox as a result of lubricant leaching out of the gear box during lure use. The present invention provides a novel solution to these inefficiencies.

The improved mechanical lure preferably includes a housing, an internal spring gearbox, one or more appendages, a plastic heat-shrink sealing film, a plastic or rubber gearbox casing and at least one hook. The housing preferably includes two housing members that are affixed to each other during assembly to contain the lure's internal mechanism and appendage connections, and which, when assembled, represent gamefish prey, such as a frog, as is shown in this embodiment, or other lure designs.

The gearbox includes a gearbox unit, a winding reel and a pulling line. A winding shaft and an offset drive shaft extend from a bottom of the gearbox unit. The pulling line is retained on the winding reel and the winding reel is secured on the winding shaft. The gearbox unit is injected with a suitable lubricant such as a grease that is formulated for plastic gears. A plastic film, preferably a plastic heat-shrink film, is applied around the gearbox perimeter to seal the openings of the gearbox and to contain the lubricant within the gearbox cavity. A plastic or rubber casing is applied to the gearbox and the plastic sealing film to provide further reduction of water circulation and particle and debris contamination within the gearbox and to reduce lubricant leaching from the gearbox during lure use.

In the embodiment shown herein of a mechanical lure in the form of a frog, the lure is fitted with a pair of legs that are connected internally to the spring gearbox to provide a swimming-like action to the legs. However, it should be noted that the improvements described herein can be applied to other gamefish prey embodiments as well as other fishing lure designs.

The pair of legs includes a first leg, a second leg, a first leg drive member and a second leg drive member. The first leg drive member includes a first leg projection, a drive member and a leg engagement member. The drive member and the leg engagement member preferably extend from the first leg projection in a “Y” shape. The drive member includes a drive slot. The leg engagement member includes a leg slide projection. The second leg drive member includes a second leg projection and a driven member.

The driven member extends from the second leg projection. An access slot is formed through the driven member to receive the leg slide projection. The first and second leg drive members are pivotally retained by at least one of the first and second housing halves. The first leg is shaped to resemble a frog's left leg and foot. A first projection hole is formed in an end of the first leg to receive the first leg projection. The second leg is shaped to resemble a frog's right leg and foot. A second projection hole is formed in an end of the second leg to receive the second leg projection.

The first and second legs are preferably fabricated from a thermoplastic elastomer (TPE) or any other suitable plastic material. The material has a specific gravity of approximately 1.0 or less to allow the first and second legs to float during use, which adds buoyancy to the improved mechanical lure to ensure optimal flotation. Thermoplastic elastomers have the desired characteristics of low modulus and high flexibility and can be repeatedly stretched to twice their original length in normal outdoor temperatures and then return to their approximate original length when the stress is released. Further, the flexibility allows the first and second legs to bend or flex when a fish “strikes” the improved mechanical lure, thus exposing the at least one treble hook. If the first and second legs were fabricated from a more rigid material, they would tend to block or shield the hooks and the fish would have a lower probability of being hooked.

Accordingly, it is an object of the present invention to provide an improved mechanical lure which provides means to enhance the performance and service life of the mechanical lure's internal spring gearbox during use in outdoor bodies of water;

It is another object of this invention to provide means for the injection of a plastic gear lubricant into the mechanical lure's internal spring gearbox and to protect said lubricant from leaching out of the gearbox during lure use;

It is another object of this invention to provide means to improve the resistance of water particle and debris contamination of the mechanical lure's internal spring gearbox during lure use;

It is yet another object of the present invention to provide an improved mechanical lure, in which the gearbox protective means consist of a plastic sealing film that is applied to the exterior of the spring gearbox and a plastic or rubber gearbox casing that encapsulates the spring gearbox and plastic sealing film to provide optimum gearbox resistance to water circulation and resultant particle and debris contamination and lubricant leaching;

It is further object of the present invention to provide an improved mechanical lure, which includes a pair of flexible and buoyant legs to provide additional flotation of the lure and optimum fish hooking capability during lure use.

These and additional objects, advantages, features and benefits of the present invention will become apparent from the following specification.

### BRIEF DESCRIPTION OF THE DRAWINGS

FIG. 1 is a perspective view of an improved mechanical lure in accordance with the present invention.

FIG. 2 is a side view of an improved mechanical lure in accordance with the present invention.

FIG. 3 is a bottom view of an improved mechanical lure with a lower housing member removed to show a winding reel, a lower case member, a first leg drive member and a second leg drive member in accordance with the present invention.

FIG. 4 is an enlarged exploded top view of a first leg drive member, a second leg drive member, a first leg and a second leg of an improved mechanical lure in accordance with the present invention.

FIG. 5 is an enlarged top view of a first leg drive member, a second leg drive member, a first leg and a second leg assembled of an improved mechanical lure in accordance with the present invention.

FIG. 6 is a cross sectional view of an improved mechanical lure in accordance with the present invention.

FIG. 7 is a perspective exploded view of an upper case member, a gearbox unit, a plastic sealing film, a lower case member and a winding reel of an improved mechanical lure in accordance with the present invention.

FIG. 8 is a perspective view of a plastic sealing film surrounding a perimeter of a gearbox unit of an improved mechanical lure in accordance with the present invention.

### DETAILED DESCRIPTION OF THE PREFERRED EMBODIMENTS

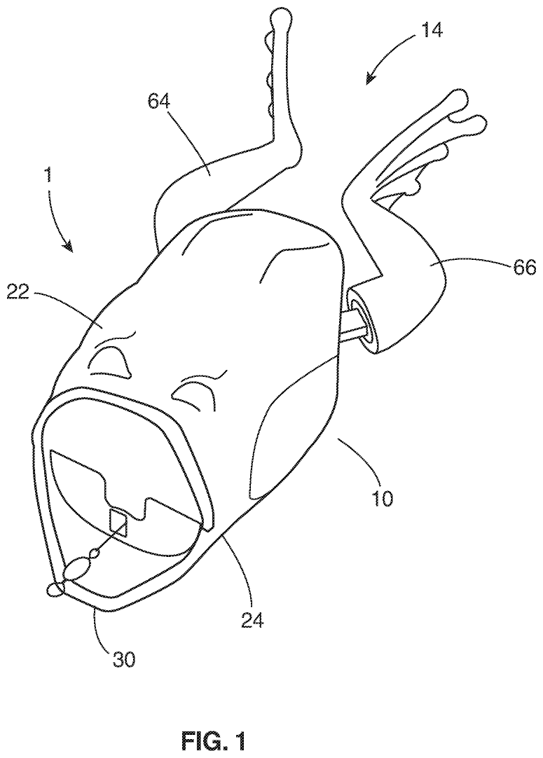

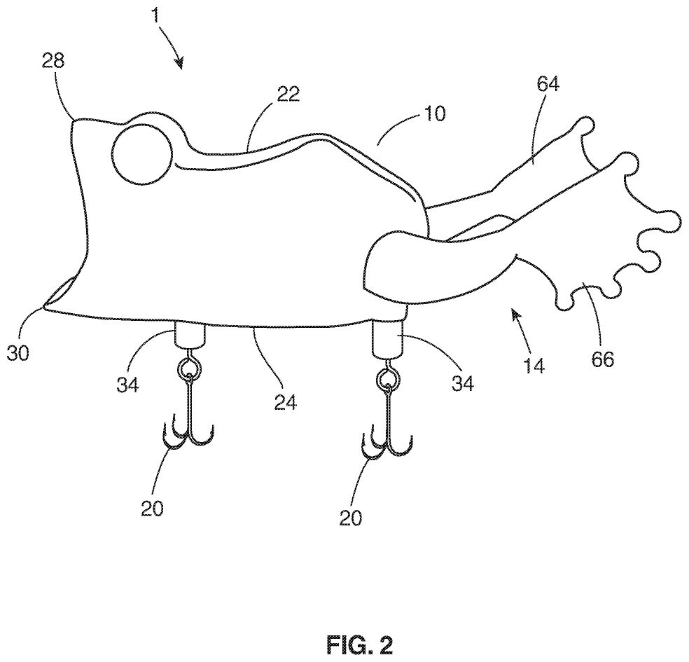

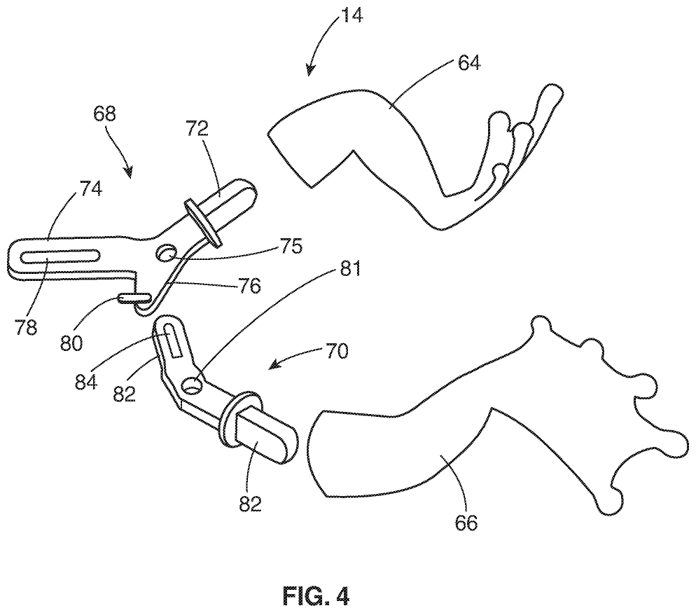

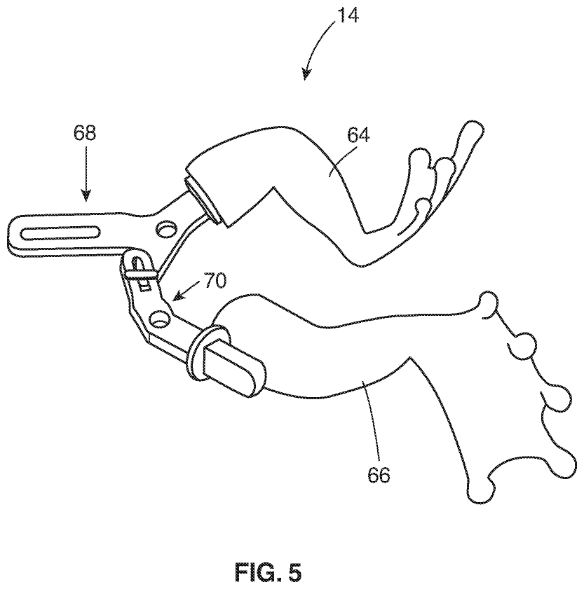

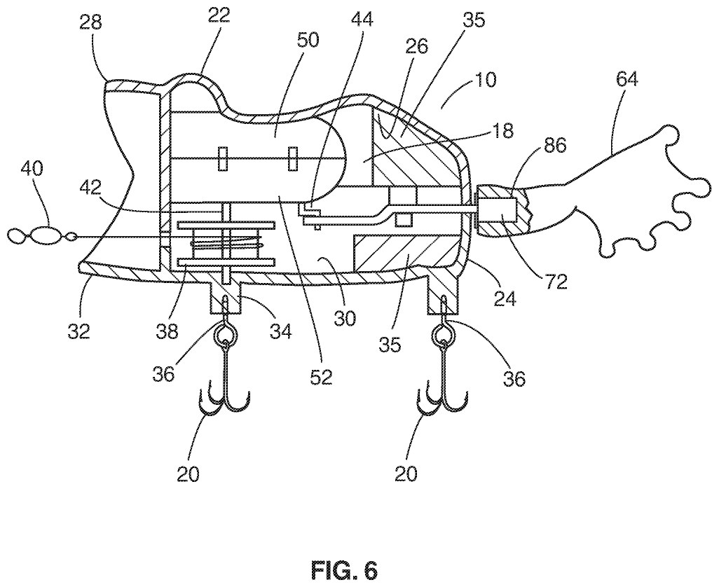

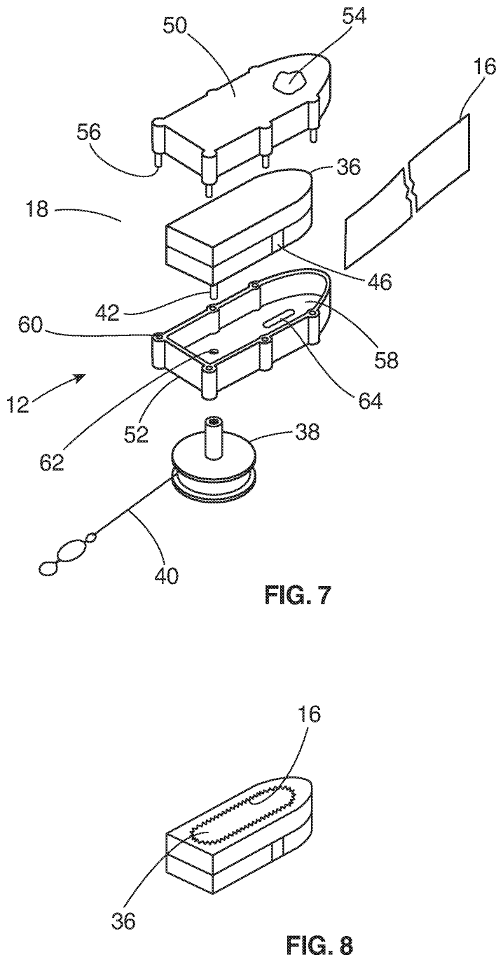

With reference now to the drawings, and particularly to FIG. 1, there is shown a perspective view of an improved mechanical lure 1. With reference to FIGS. 2-8, the improved mechanical lure 1 preferably includes a housing 10, a gearbox 12, a pair of legs 14, a plastic sealing film 16, gearbox case 18 and at least one treble hook 20. The housing 10 preferably includes an upper housing member 22 and a lower housing member 24. The upper housing member 22 preferably includes an outer surface that resembles a top of a game fish prey and an upper inner cavity 26.

The improved mechanical lure 1 should not be limited to a frog, but could be any gamefish prey or lure design. The upper housing member 22 includes an upper lip 28 formed on a front of the upper housing member 22. The lower housing member 24 includes an outer surface that resembles a bottom of the aquatic creature and a lower inner cavity 30. The lower housing member 24 includes a lower lip 32 formed on a front of the lower housing member 24 and at least one hook projection 34. The lower lip 32 is sized to provide enough drag to allow a gearbox spring (not shown) inside the gearbox 12 to be wound during reeling of a fishing line of a fishing rod. The at least one hook 20 is secured to the at least one hook projection 34 with at least one fastener 36. It is preferable to attach foam 35 in the upper and lower cavities 26, 30 for additional lure buoyancy.

The gearbox 12 includes a gearbox unit 36, a winding reel 38 and a pull line 40. The gearbox unit 36 includes an energy storage drive device (illustrated in U.S. Pat. Nos. 5,035,075 and 6,622,419), a winding shaft 42 and an offset drive shaft 44. The winding shaft 42 and the offset drive shaft 44 extend from a bottom of the gearbox unit 36. The energy storage drive device receives a rotational input from the winding shaft 42 and outputs a rotational motion through the offset drive shaft 44. The pull line 40 is retained on the winding reel 38 and the winding reel 38 is secured on the winding shaft 42. The gearbox 12 disclosed in this application is substantially the same as the gearbox 38 disclosed in U.S. Pat. No. 6,622,419 and similar to the windup mechanisms 80 and 340. U.S. Pat. Nos. 5,035,075 and 6,622,419 are hereby incorporated by reference in their entirety. The gearbox unit 36 is injected and filled with a lubricant through a lubricant access opening 46. The lubricant is preferably a grease that is designed for plastic gears. The plastic sealing film 16 is applied to seal a lubricant injection opening 46 or to a perimeter of the gearbox unit 36 to seal the lubricant injection opening 46 as well as other perimeter openings in the gearbox. The plastic sealing film 16 is preferably plastic heat-shrink wrap, that is shrink wrapped around a perimeter of the gearbox unit 36. The gearbox case 18 includes an upper case member 50 and a lower case member 52. The upper case member 50 includes an upper case cavity 54 and a plurality of pin projections 56. The upper case cavity 54 is sized to receive a perimeter of the gearbox unit 36. The plurality of pin projections 56 are located around a perimeter of the upper case member 50. The lower case member 52 includes a lower case cavity 58 and a plurality of reception holes 60. The lower case cavity 58 is sized to receive a perimeter of the gearbox unit 36. The plurality of reception holes 60 are located around a perimeter of the lower case member 52 to receive the plurality of pin projections 56. A shaft hole 62 and a drive slot 64 are formed through the lower case member 52 to provide clearance for the winding shaft 42 and the drive shaft 44, respectively. A mating surface of the upper and lower case members 50, 52 are attached to each other with a bonding process.

The plastic sealing film 16 and the gearbox case 18 are used to prevent water contaminants from entering into the gearbox 12 and fouling or disabling the energy storage drive device inside the gearbox unit 36.

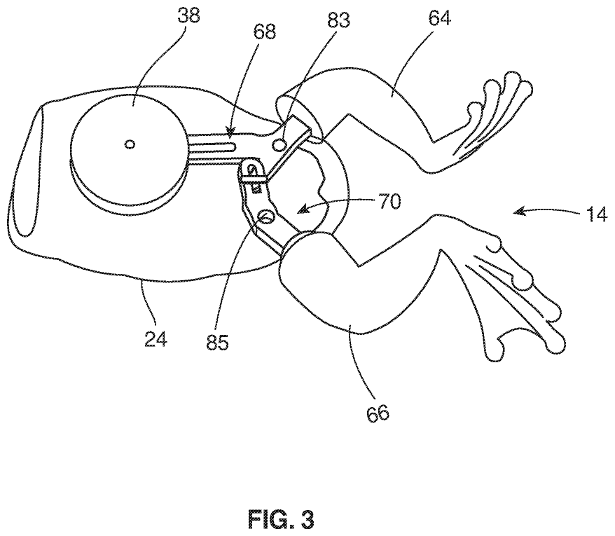

With reference to FIGS. 3-5, the pair of legs 14 include a first leg 64, a second leg 66, a first leg drive member 68 and a second leg drive member 70. The first leg drive member 68 includes a first leg projection 72, a drive member 74, a first pivot hole 75 and a leg engagement member 76. The drive member 74 and the leg engagement member 76 preferably extend from the first leg projection 72 in a substantial “Y” shape. The drive member 74 includes a drive slot 78. The leg engagement member 76 includes a leg slide projection 80. The second leg drive member 70 includes a second leg projection 80, a second pivot hole 81 and a driven member 82. The driven member 82 extends from the second leg projection 80. An access slot 84 is formed through the driven member 82 to receive the leg slide projection 80. The first leg drive member 68 is pivotally retained by a first pin 83 extending from the upper or lower housing halves 22, 24, inserted through the first pivot hole 75. The second leg drive member 70 is pivotally retained by a second pin 85 extending from the upper or lower housing halves 22, 24, inserted through the second pivot hole 81. The first leg 64 is shaped to resemble a frog's left leg and foot. A first projection hole 86 is formed in an end of the first leg 64 to receive the first leg projection 72. The second leg is shaped to resemble a frog's right leg and foot. A second projection hole (not shown) is formed in an end of the second leg 66 to receive the second leg projection 82. Rotation of said offset drive shaft 44 causes said first and second legs 64, 66 to have an oscillating motion.

The first and second legs 64, 66 are preferably fabricated from a thermoplastic elastomer (TPE) or any other suitable plastic material. The material has a specific gravity of approximately 1.0 or less to allow the first and second legs 64, 66 to float during use. The material adds buoyancy to the improved mechanical lure 1 to ensure optimal flotation. The buoyancy of the first and second legs 64, 66 further allow a larger surface area of the first and second legs 64, 66 to reside substantially above the water during use, which provides the following advantages: (1) the first and second legs 64, 66 residing above the water line are visible to the user during use of the improved mechanical lure 1, which increases the enjoyment of use since the first and second legs 64, 66 are readily observable to the user, even at distances achieved with long casts of the improved mechanical lure 1; and (2) the user can also easily determine when the first and second legs cease motion, so that the fisherman may reactivate the improved mechanical lure through a popping or jerking motion of the fishing rod which loads the spring in the gearbox a new cycle of leg and feet motion.

Thermoplastic elastomers (TPE) have the desired characteristics of low modulus and high flexibility and can be repeatedly stretched in normal outdoor temperatures and then return to their approximate original length when the stress is released. It has been determined by the inventor that this is ideal for fishing lure applications. Further, the flexibility allows the first and second legs 64, 66 to bend or flex when a fish “strikes” the improved mechanical lure 1, thus exposing the at least one hook 20. If the first and second legs 64, 66 were fabricated from a more rigid material, they would tend to block or shield the at least one hook 20 and the fish would have a lower probability of being hooked.

Additionally, the TPE material can be formed with optimal stiffness to cause the first and second legs to fully move (kick) back and forth in water, while still allowing the first and second legs to bend or fold when a fish strikes the improved mechanical lure, so that the at least one hook is not shielded from the fish's mouth. If the first and second legs 64, 66 are of less than optimally stiffness, the first and second legs 64, 66 will not fully open and close in water since the resistance of the water will cause the first and second legs 64, 66 to vibrate rather than fully open and close. Further, the first and second legs 64, 66 must be of sufficient flexibility to allow the first and second legs 64, 66 to bend and fold such that the at least one treble hook 20 is sufficiently exposed to facilitate hooking of the fish when the fish strikes the improved mechanical lure 1.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. An improved mechanical lure, comprising:
a housing having an inner cavity;
a gearbox includes a gearbox unit, a winding reel and a lubricant opening, said gear box unit includes an energy storage device, said energy storage device receives input from rotation of said winding reel and outputs rotation through a drive shaft, said gearbox is retained in said inner cavity;
a grease is applied into the gear box unit which will not react with the plastic gears therein; and
a plastic sealing film is applied over said housing.

2. The improved mechanical lure of claim 1, further comprising:
a first leg engaged with said drive shaft; and
a second leg driven by said drive shaft, wherein rotation of said drive shaft causes ends of said first and second legs to have motion.

3. The improved mechanical lure of claim 1, further comprising:
a pull line is retained on said winding reel.

4. The improved mechanical lure of claim 1, further comprising:
a first leg drive member extends from said first leg, a second leg drive member extends from said second leg, said first leg is slidably engaged with said drive shaft through said first leg drive member, said second leg drive member is slidably engaged with said first leg drive member, said first and second leg drive members are pivotally engaged with said housing.

5. The improved mechanical lure of claim 1 wherein:
said first and second legs are fabricated from a thermoplastic elastomer (TPE) having a specific gravity of 1.0 or less.

6. The improved mechanical lure with of claim 1 wherein:
said housing includes a lower lip, a size of said lower lip is optimized to provide enough drag to wind said winding reel with a fishing reel.

7. The improved mechanical lure of claim 1 wherein:
said housing includes a first housing member and a second housing member.

8. A improved mechanical lure, comprising:
a housing having an inner cavity;
a gearbox includes a gearbox unit and a winding reel, said gearbox unit includes a lubricant opening and an energy storage device, said energy storage device receives input from rotation of said winding reel and outputs rotation through a drive shaft, said gearbox is retained in said inner cavity;
a grease is applied into the gear box unit which will not react with the gears therein;
a plastic sealing film is applied over said gearbox unit; and
a gearbox case includes an upper case member and a lower case member, said gearbox unit with plastic sealing film is retained in said upper and lower case members.

9. The An improved mechanical lure of claim 8, further comprising:
a first leg engaged with said drive shaft; and
a second leg driven by said drive shaft, wherein rotation of said drive shaft causes ends of said first and second legs to have motion.

10. The improved mechanical lure of claim 8, further comprising:
a pull line is retained on said winding reel.

11. The improved mechanical lure of claim 8, further comprising:
a first leg drive member extends from said first leg, a second leg drive member extends from said second leg, said first leg is slidably engaged with said drive shaft through said first leg drive member, said second leg drive member is slidably engaged with said first leg drive member, said first and second leg drive members are pivotally engaged with said housing.

12. The improved mechanical lure of claim 8 wherein:
said first and second legs are fabricated from a thermoplastic elastomer (TPE) having a specific gravity of 1.0 or less.

13. The improved mechanical lure of claim 8 wherein:
said housing includes a lower lip, a size of said lower lip is optimized to provide enough drag to wind said winding reel with a fishing rod and reel.

14. The improved mechanical lure of claim 8 wherein:
said housing includes a first housing member and a second housing member.

15. A improved mechanical lure with articulated legs, comprising:
a housing having an inner cavity;
a gearbox includes a gearbox unit and a winding reel, said gearbox unit includes an energy storage device, said energy storage device receives input from rotation of said winding reel and outputs rotation through a drive shaft, said gearbox is retained in said inner cavity;
a first leg is engaged with said drive shaft, said first leg is fabricated from a flexible material; and
a second leg is driven by said drive shaft, said second leg is fabricated from said flexible material, wherein rotation of said drive shaft causes ends of said first and second legs to have motion.

16. The improved mechanical lure with articulated legs of claim 15, further comprising:
a pull line is retained on said winding reel.

17. The improved mechanical lure with articulated legs of claim 15, further comprising:
said gearbox unit is filled with a grease lubricant.

18. The improved mechanical lure with articulated legs of claim 15, further comprising:
a first leg drive member extends from said first leg, a second leg drive member extends from said second leg, said first leg is slidably engaged with said drive shaft through said first leg drive member, said second leg drive member is slidably engaged with said first leg drive member, said first and second leg drive members are pivotally engaged with said housing.

19. The improved mechanical lure with articulated legs of claim 15 wherein:
said first and second legs are fabricated from a thermoplastic elastomer (TPE) having a specific gravity of 1.0 or less.

20. The improved mechanical lure with articulated legs of claim 15 wherein:
said housing includes a lower lip, a size of said lower lip is optimized to provide enough drag to wind said winding reel with a fishing reel.
